(19) United States
(12) Patent Application Publication
(10) Pub. No.: US 2003/0161023 A1
(43) Pub. Date: Aug. 28, 2003

(54) Light-emitting systems

(76) Inventors: William Paul Gillin, Surrey (GB); Richard James Curry, Hampshire (GB)

Correspondence Address: YOUNG & THOMPSON, 745 SOUTH 23RD STREET 2ND FLOOR, ARLINGTON, VA, 22202

(21) Appl. No.: 10/240,457

(22) PCT Filed: Mar. 22, 2001
(86) PCT No.: PCT/GB01/01252

(51) Int. Cl. G02F 1/03; G02F 1/07

(52) U.S. Cl. 359/247

(57) ABSTRACT

A light-emitting system comprises a rare earth-containing organic light-emitting device (10, 11, 12, 13) fabricated on a silicon-based substrate (1). The light-emitting device is associated with a resonant cavity which may be in the form of a ridge or buried ridge waveguide (6). A diode (27) may form a modulator region (26) for injection of free carriers into the waveguide. This changes the refractive index or local absorption of the resonant cavity and thus allows switching of the system. The system is preferably a laser operating at about 1.5 μm although other wavelengths may be used. The wavelength is selected by the rare earth used.

This invention relates to light-emitting systems, and is concerned more particularly, but not exclusively, with devices for use in microprocessors and telecommunications systems for emitting light into optical fibres.

As used herein, the words “light-emitting device” and “light-emitting system” are used to describe a device or system which emits electromagnetic radiation of any wavelength, and are not intended to be limited to systems emitting light in the visible spectrum.

Inter and intra chip communication in microprocessors currently relies upon electrical interconnects to exchange information. As the clock frequency of microprocessors increases these interconnects will become one of the limiting factors in the performance of devices utilising such processors.

One solution to this problem is to use optical connects for such communication. Current approaches to this solution however, have many inherent disadvantages. It is desirable to create a light source that is compatible with silicon, since this is the preferred material for microprocessors. Current light sources are based upon III-V compound semiconductors. Due to the lattice mismatch between these materials and silicon they cannot be grown directly onto the silicon substrates which contain the signal processing and driving electronics.

A further consequence of the fact that silicon is the preferred material for microprocessors is that any intra chip optical interconnect should preferably use light having an energy above the band edge of silicon (1.12 eV, corresponding to a wavelength of 1.1 μm) so that simple silicon based photodiodes can be used as detectors.

The above desired requirements for intra and inter chip communication has be effect that current proposals for optical interconnects comprise of numerous components which all need to be integrated.

Current optical fibre telecommunications systems operate at wavelengths around 1.5 μm, since this is the low loss window for silica optical fibres. The laser sources currently used for telecommunications are based on III-V compound semiconductors. As mentioned above it has not been possible to grow such structures directly onto the silicon substrates which are used for signal processing and for driving the laser.

This has the effect that the chip driving the laser and the laser itself must be different entities. The whole set-up is complicated, comprising a chip, laser, lens and means for holding a fibre in place.

The use of erbium in telecommunications is well established in optical regeneration of signals using erbium-doped fibre amplifiers. Erbium is particularly useful as it has an intra-atomic transition within the 4f level of the Er³⁺ ion between the first excited state (₄I_{13/2}) and the ground state (⁴I_{15/2}) which emits at ˜1.54 μm. There have been many attempts to dope silicon directly with erbium to produce luminescence but there are still problems in obtaining efficient, bright, luminescence at room temperature.

Electroluminescence from organic materials has been a subject of increasing interest in recent years. In 1987 Tang and VanSlyke [C. W. Tang and S. A. VanSlyke, Appl. Phys. Lett, 51(12), 913, 1987] demonstrated that it was possible to obtain visible electroluminescence, with a peak emission wavelength of ˜510 μm, from aluminium tris-(8-hydroxyquinoline) (AIQ) based diodes. Considerable work has been done since then on improving the brightness, efficiency and reliability of organic light emitting devices (OLEDs), and AIQ has remained one of the most widely used emitting materials.

Since then it has been demonstrated, for example by R. J. Curry and W. P. Gillin, Appl. Phys. Lett., 75(10), 1380, 1999 and O. M. Khreis, R. J. Curry, M. Somerton, W. P. Gillin, J. Appl. Phys., 88(2), 777, 2000 that by the incorporation of the rare earth elements erbium, neodymium and ytterbium it is possible to produce OLEDs with emission wavelengths centred at: 1.532 μm using erbium, 0.9 μm, 1.064 μm and 1.337 μm using neodymium and 980 nm using ytterbium. Further more it has been demonstrated that these devices can be integrated directly on to a silicon substrate. For the erbium containing device this produces a silicon based OLED operating at 1.532 μm, as shown by R. J. Curry, W. P. Gillin, A. P. Knights, R. G. William, Appl. Phys. Lett., 77(15), 2271, 2000.

It is possible to produce useful devices from these organic materials. However, lasers for use in telecommunications must be switched at extremely high speeds, and it may not be possible for OLEDs to be switched fast enough for many applications using current techniques.

According to a first aspect of the invention there is provided a light-emitting system comprising an organic light-emitting device containing a rare earth fabricated on a silicon-based substrate, and a resonant cavity within which light emitted by said light-emitting device propagates.

The rare earth is preferably erbium, neodymium or ytterbium.

Silicon is cheaper and much easier to process than III-V semiconductors, so that light-emitting systems fabricated using silicon alone will in general be cheaper to manufacture than those fabricated from III-V semiconductors. A device according to the invention may also in certain circumstances be more stable with temperature than III-V devices.

The light-emitting system preferably operates at about 1.5 μm, which allows light emitted by the system to be transmitted through silica optical fibres. However, if the device is used as an inter- or intra-chip optical interconnect, the short distances involved mean that the higher loss in silica is acceptable or that other fibre materials or free space transmission could be used thus other wavelengths can be used. Preferred examples of operating wavelengths include 0.9 μm and 1 μm. The operating wavelength is determined by the rare earth used in the light-emitting device.

In preferred embodiments, the resonant cavity comprises a waveguide structure on the silicon-based substrate, the waveguide structure having reflective means at each end so as to form the resonant cavity.

There are several possible means of making a waveguide. In one embodiment the waveguide is a ridge waveguide, but may also be formed for example in a slab of silicon by doping the regions either side of a light propagation region. The light-emitting device may be integrated into the waveguide structure.

However, for wavelengths shorter than ˜1.1 μm which allow the use of conventional silicon photodiodes as detectors, it is not possible to produce a waveguide in the silicon itself as the silicon is strongly absorbing. If such wavelengths are to be used, the waveguide may be a planarised or buried ridge waveguide. This may be fabricated from dielectric materials such as silicon oxide, silicon nitride or silicon oxynitride materials.

The reflective means may be, for example, mirrors or Bragg reflectors.

The light-emitting system is preferably a laser. A laser formed from a rare earth containing OLED and a resonant cavity formed in the waveguide will emit Continuons Wave (CW) light. If the rare earth is erbium then the CW light will be emitted at about 1.5 μm.

As mentioned above, it may be that organic lasers cannot be switched fast enough for many telecommunications applications. According to a second aspect, therefore, the present invention provides a light-emitting system comprising an organic light-emitting device fabricated on a silicon-based substrate, a resonant cavity within which light emitted by said light-emitting device propagates, and a modulator associated with the resonant cavity. The modulator may be located in the waveguide and integrated into the silicon, in which case the modulator may be a diode for the injection of free carriers into the waveguide.

The injection of free carriers may change the refractive index or local absorption of the waveguide so as to modulate laser beam.

Alternatively, the modulator may be a polymer or small molecule organic waveguide modulator.

Thus, rather than attempting to switch the part of the device that is actually lasing, an electronic “shutter” can be used to switch much more rapidly.

The substrate may incorporate a groove for receiving an optical fibre. This has the advantage that in certain circumstances no lens will be required and a single device can be used for the electrical processing and optical output of the signal. This should be simpler to fabricate than a device comprising a chip, laser, lens and fibre holder, and should therefore also be cheaper to fabricate than such a device. It also provides the possibility that the device can be small enough to use for inter and intra chip communication.

Some preferred embodiments of the invention will now be described by way of example only and with reference to the accompanying drawings, in which:

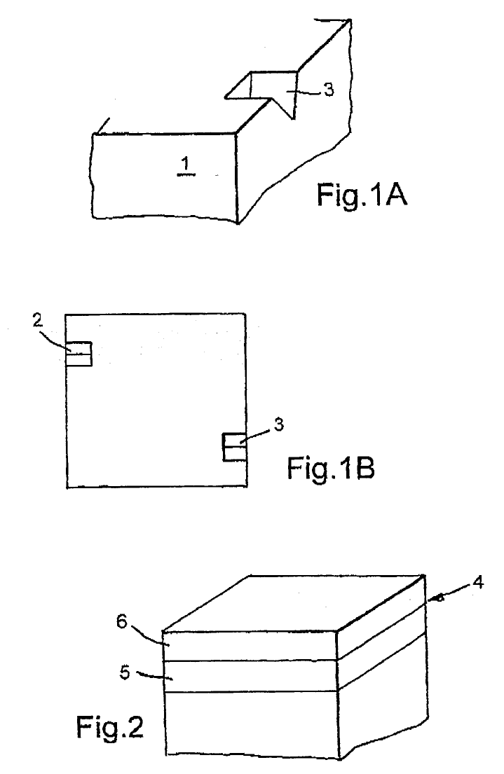

FIG. 1A is a schematic view of a silicon substrate prior to the formation of a device according to a first embodiment of the present invention, FIG. 1B being a plan view of the substrate;

FIG. 2 is a schematic view of the silicon substrate of FIG. 1 on to which two dielectric layers have been deposited so as to form a planar waveguide;

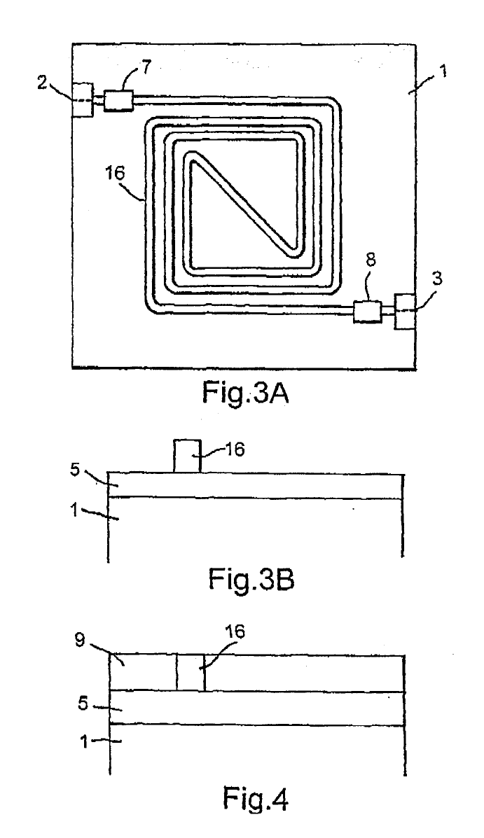

FIG. 3A is a plan view of the waveguide of FIG. 2 following etching to produce a waveguide structure, FIG. 3B being a cross-sectional view of the waveguide structure;

FIG. 4 is a cross-sectional view of the waveguide structure of FIG. 3 following planarisation;

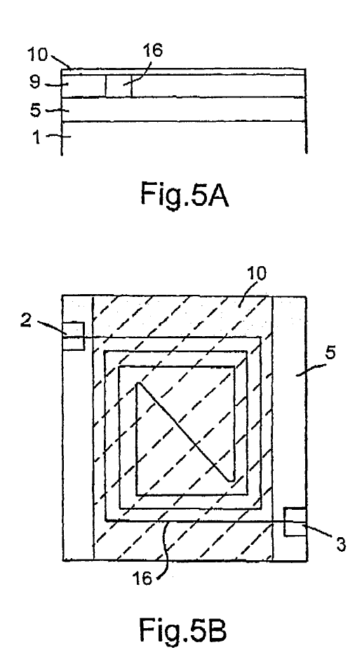

FIG. 5A is a cross-sectional view of the waveguide structure of FIG. 4 following the deposition of a layer of Indium Tin Oxide (ITO), FIG. 5B being a plan view of the waveguide structure and ITO layer;

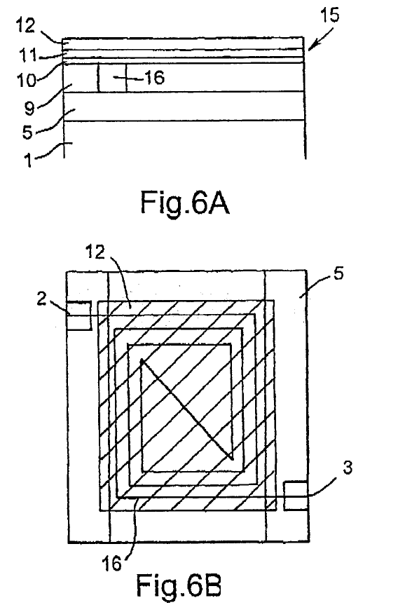

FIG. 6A is a cross-sectional view of the assembly of FIG. 5 following the deposition of organic layers, FIG. 6B being a plan view of the assembly;

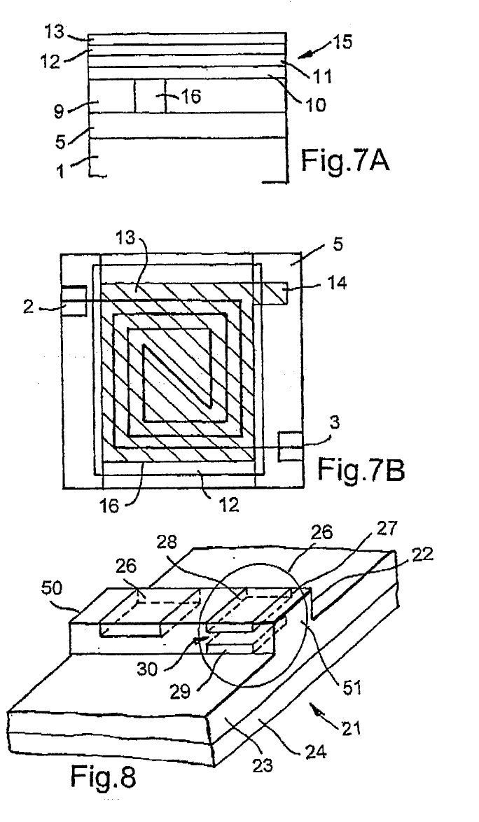

FIG. 7A is a cross-sectional view of a device in accordance with the invention formed by the deposition of a metal contact on the assembly of FIG. 6, FIG. 7B being a plan view of the device;

FIG. 8 shows schematically a second embodiment of a light-emitting device in accordance with the invention fabricated using an OLED integrated with a waveguide on a silicon-on-insulator substrate;

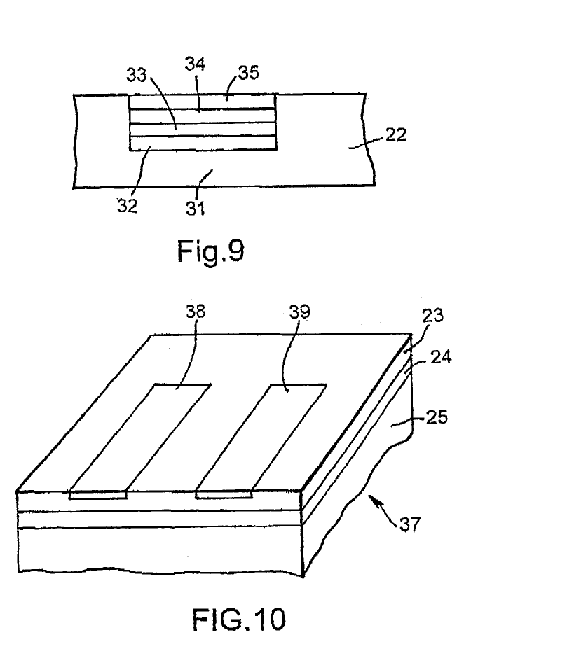

FIG. 9 is a schematic section through the OLED region of the device of FIG. 8;

FIG. 10 shows schematically a first stage in the manufacture of the device of FIG. 8;

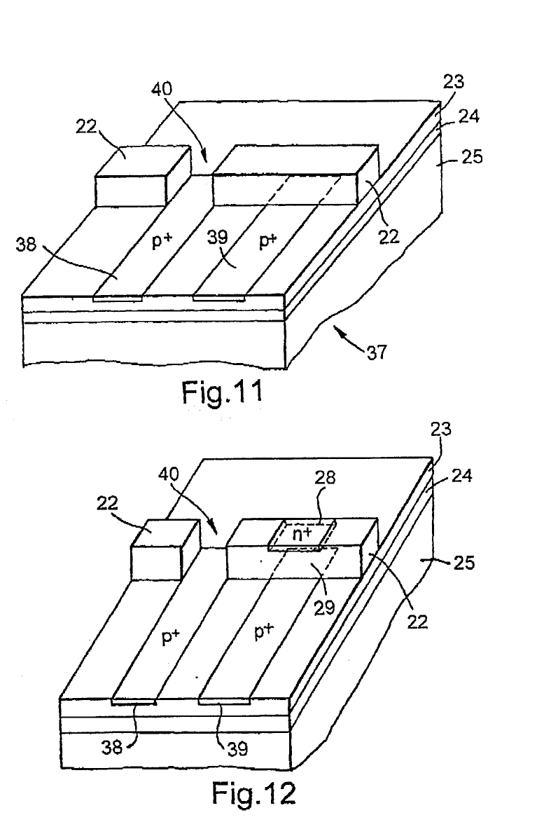

FIG. 11 shows schematically a second stage in the manufacture of the device of FIG. 10;

FIG. 12 shows schematically a third stage in the manufacture of the device of FIG. 10;

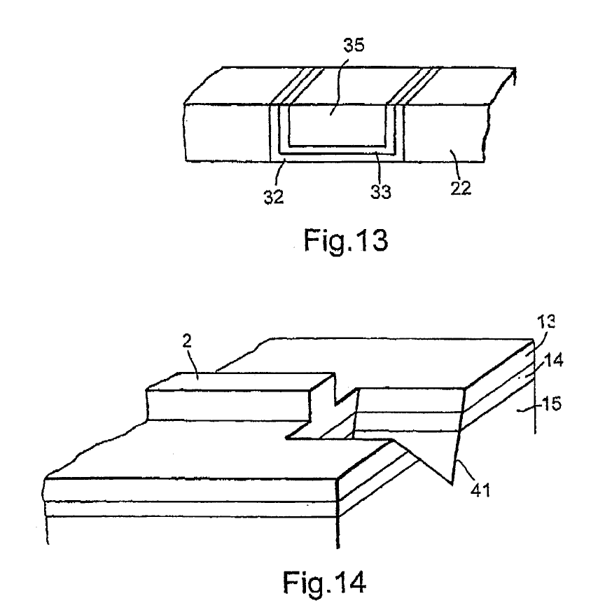

FIG. 13 shows an expanded view of the OLED region of the device of FIG. 10; and

FIG. 14 shows a groove for receiving an optical fibre formed on a device according to the invention.

The manufacture of a first embodiment of a laser according to the invention will now be described with reference to FIGS. 1 to 7.

FIG. 1 shows a silicon substrate 1 with two V-grooves 2, 3 etched into it. These are positioned so that a waveguide structure to be fabricated on the substrate 1 will terminate at the V-grooves, and so that an optical fibre placed in these grooves will be aligned with the waveguide.

FIG. 2 shows the silicon wafer 1 of FIG. 1 onto which has been deposited a planar waveguide 4. The planar waveguide 4 is formed of two components. A layer 5 of low refractive index dielectric material, for example silicon dioxide with a refractive index of ˜1.48, is deposited directly on to the silicon 1 and a layer 6 of higher refractive index dielectric material, e.g. silicon nitride with a refractive index of ˜2.1, deposited on this. The layers 5, 6 are deposited by chemical vapour deposition or another suitable method. The thickness of the two layers 5, 6 depends on the wavelength of the light to be used in the laser but should be such that part of the guided wave will also be travelling in the organic layers which will be placed above this waveguide. The layers may be any suitable dielectric material but one suitable material may be silicon oxynitride (SiOₓN_{y}) in which the refractive index can be easily controlled by the oxygen/nitrogen ratio in the layers.

Following the deposition of the planar waveguide 4, the top layer 6 is photolithographically patterned and etched to form a ridge waveguide 16 with integral Bragg reflectors 7, 8 as shown in FIGS. 5A and 5B. The ends of the waveguide 16 terminate at the V-grooves 2, 3 such that the centre of the optical fibre will be coincident with the centre of the waveguide 16. The waveguide 16 takes the form of a “coiled” or spiral pattern to allow for a long gain region to be achieved on a small area of silicon. As seen in FIG. 5B, the waveguide 16 is formed by etching through the layer 6 of high refractive index material down to the layer 5 of low refractive index material. The dimensions of the waveguide 16 and periodicity of the Bragg reflectors 7, 8 is chosen so as to act as a resonant cavity and reflector respectively for the wavelength of light to be emitted by the organic light-emitting diode (OLED). Both the pattern of the waveguide 16 and the Bragg reflectors 7, 8 are etched from the planar waveguide using standard photoresist and lithography techniques

As seen from FIG. 4, following the manufacture of the ridge waveguide 16 the device is planarised with a layer 9 of low refractive index material such as a spin on glass. The refractive index of this layer 9 must be lower than that of the layer 6 from which the waveguide 16 has been etched. This serves several functions. It provides a flat surface onto which an OLED can be deposited so as to ease manufacture, it provides a well characterised low refractive index material to surround the waveguide 16 in order to improve the waveguide properties and it provides some mechanical protection to the waveguide 16. This planarisation may be performed in a number of ways, for example using spin on glasses or Chemical Vapour Deposition (CVD). The deposition will leave an uneven surface. Following the deposition the glass 9 can be planarised back to the top of the waveguide 16 using either a chemical etchant or by chemical mechanical polishing so as to leave the structure shown in FIG. 4.

As shown in FIG. 5, after the planarised waveguide 16 has been produced an Iudium Tin Oxide (ITO) layer 10 is deposited over the waveguide. This ITO layer acts as an anode for the OLED to be formed above it. As can be seen from FIG. 5A, the ITO 10 is deposited over the whole of the waveguide 16. The thickness of to ITO layer 10 and the indium and tin concentrations are chosen to optimise the ITO for the injection of charge into the device and the coupling of light into the waveguide 16.

As seen in FIG. 6A, two organic layers 11, 12 are deposited on the ITO layer 10 so as to form an organic light-emitting diode (OLED) 15. The lower organic layer 11 is a hole transporting layer and the upper organic layer 12 is an electron transporting and emitting layer. The upper layer 12 contains rare earth containing molecules which provide light emission. It will be understood that the device may contain extra layers either to improve the hole injection or to block exciton transport. Alternatively, the rare earth containing molecules may be incorporated as a dopant within a charge transporting layer. The thickness of each of the organic layers 11, 12 is chosen so as to optimise the performance of the OLED 15.

In the preferred device structure the hole transport layer 11 is deposited on to the ITO layer 10 followed by the electron transporting and emitting layer 12. However, this does not exclude other device configurations in which the electron transporting and emitting layer is placed on the ITO layer 10 followed by the hole transporting layer. Such a structure again does not preclude the incorporation of additional layers as mentioned above to improve device performance. The deposition of the organic layers 11, 12 extends over the whole waveguide 16 region of the device and beyond the edges of the ITO layer 10. This will ensue that there is no short circuit between the ITO and the subsequent metal contact.

As shown in FIG. 7, following the organic deposition a metal cathode electrode 13 is deposited. The electrode 13 again extends over the whole of the waveguide 16 structure but not beyond the organic layers 11, 12 except in one corner 14 to make contact with the underlying silicon 1 to connect to the rest of the device. The cathode material is a low work function metal followed by a protective metal overlayer.

The device as shown in FIG. 7 will perform as a laser. The OLED 15 formed by the ITO layer 10, organic layers 11, 12 including rare earth containing layer 12; and metal cathode 13 produces light whose wavelength is determined by the rare earth ion used. The light is transmitted into the waveguide 16 which acts as a laser cavity due to the Bragg reflectors 7, 8 at each end.

The device as shown in FIG. 7 will work in continuous wave (CW) operation, or may be modulated through stitching the current around the threshold current for laser operation. If very high frequency modulation is desired an optical modulator is incorporated either external to the device or integrated with the laser cavity.

There are a number of possible approaches to producing this modulator. In the simplest case the modulator is formed from the electro-optic materials, such as polymers, described earlier. For both internal and external modulators the principle of operation is the same, with an interferometer which may be incorporated into the waveguide. The electro-optic material in one of the arms of the interferometer produces a modulated phase shift which allows for switching of the device. Such modulators have been demonstrated by Wenshen Wang, Datong Chen H. R. Fetterman, Yongqiang Shi, W. M. Steier, L. R. Dalton, Pci-Ming D. Chow, Appl. Phys. Lett, 67(13), 1806, 1995 to exhibit modulation of a laser of wavelength ˜1 μm at frequencies of up to 60 GHz.

The above embodiment describes the formation of the waveguide region from dielectric materials deposited on to the surface of silicon. For operation at wavelengths longer than the silicon bandgap, such as the 1.5 μm emission from erbium, the waveguide structure may be formed from the silicon itself. In such an embodiment the substrate 1 is a silicon-on-insulator wafer, in which the insulator layer in the wafer acts as the low refractive index dielectric layer, corresponding to layer 5 in FIG. 4, and the silicon overlayer acts as the waveguide layer 6. All subsequent fabrication would then be the same as for the first embodiment described above.

A second embodiment of the invention will now be described with reference to FIGS. 8 to 14.

FIG. 8 shows a light emitting device 21 comprising a ridge waveguide 22 fabricated on a silicon substrate 23 which incorporates a silicon oxide layer 24. An erbium containing organic light emitting diode (OLED) region 26 is provided within the waveguide as an integral part of the waveguide. A modulator region 27 is also provided within and integral with the waveguide.

The modulator region 27 is formed by a diode 28 which comprises a layer 29 of n-type silicon at the surface of the waveguide, and a layer 30 of p-type silicon embedded within the waveguide, with a layer 31 of undoped silicon sandwiched between layers 29 and 30.

Mirrors 50 and 51 are provided at each end of the waveguide 22, and the dimensions of the waveguide 22 are such that the waveguide acts as a resonant cavity for light emitted by the OLED 26.

DC operation of the OLED 26 will therefore result in a CW laser operating with a central wavelength of approximately 1.5 μm. The rapid switching required for telecommunications applications is achieved by the use of the modulator region 27. The diode 28 injects free carriers into the waveguide 22, enabling the modulation of the laser by changing of the refractive index of the waveguide 22. When the diode 28 is activated, the refractive index of the waveguide 22 is changed so that it no longer acts as a resonant cavity or free carrier absorption reduces the gain in the cavity and the device no longer behaves as a laser. When the diode 28 is switched off the device again acts as a laser.

FIG. 9 shows the fabrication of the OLED region 26 in more detail. The base of the waveguide 22 is doped with an acceptor to form a p-type silicon layer 32. An organic hole transporting layer 33 is located above the p-type layer 32. An erbium containing organic layer 34 is located above this, and acts as the emitting layer. The erbium containing organic layer 34 preferably comprises erbium (III) tris(8-hydroxyquinoline) (ErQ) but may comprise erbium combined with any other suitable ligand which allows fox transfer of energy into the internal levels of the rare earth ion. An optional electron transmitting layer 35 is located above the erbium containing layer. This layer is not always necessary to make the device operate, but may, in certain circumstances, improve performance. Finally an n-type silicon electron injecting layer 36 is provided at the surface of the waveguide.

The thicknesses of these layers 31, 32, 33, 34, 35 are optimised both for the most efficient electrical operation of the device and for the coupling of the light into the waveguide.

A method for fabricating such a device will now be described with reference to FIGS. 10 to 13.

Referring to FIG. 10, a silicon-on-insulator wafer 37 comprises a silicon oxide layer 24 sandwiched between silicon layers 23 and 25. Base contacts 38 and 39 are formed for an OLED and pin diode modulator by creating a suitable ion implantation mask using standard photoresist and lithography techniques, and performing a boron implant to dope the two contact regions 38, 39 to form p-type regions. The photoresist is removed and the substrate annealed to activate the boron implants.

Referring to FIG. 11, the next fabrication step is to form the ridge waveguide 22. An epitaxial layer of silicon is grown on the whole surface of the substrate 23. Standard photoresist and lithography techniques are then used to define the position of the ridge waveguide 22, leaving a gap 40 in the waveguide for the location of the OLED. Then the epitaxial layer of silicon is etched away from the substrate back to the original surface everywhere except at tile waveguide 22. After this procedure a device as shown in FIG. 11 is obtained.

Referring now to FIG. 12, the diode modulator 27 is formed in a subsequent fabrication step. The area which will form the top contact 28 of the diode 27 is defined using photoresist and lithography techniques. A phosphorus implant is performed to create an n-type region 28 and the substrate is then annealed to activate the implant.

In a further fabrication step the OLED is formed. Photoresist and lithography are used to define the area which will form the OLED. The organic hole transport layer 32 and erbium containing electron transport layer 33 are deposited into this area using vacuum evaporation. These layers are evaporated so that they cover the side walls of the OLED cavity so that the top n-type silicon does not make contact with any part of the silicon waveguide, as shown in FIG. 13. The n-type silicon layer 35 is then deposited as a top contact. Photoresist and lithography techniques are then used to protect the OLED device and all the excess n-type silicon and organics are etched away.

Finally the contacts are formed. The whole device is covered in an insulating layer and photoresist and lithography techniques are used to define areas for contact formation. The insulator is then etched away in these areas and the photoresist removed. Photoresist and lithography techniques are used to define the areas for contact evaporation. The contact metal is then evaporated and lift-off used to define the contacts. These contacts will connect the laser and modulator directly to existing driver/signal processing electronics.

Both of the above described arrangements have the advantage that the diver/signal processing electronics can be located on the same piece of silicon as the laser. If separate drive chips are used the final metal contacts would connect to large areas of metal from which the device would be wire bonded to contact pins or to another chip. If the devices are small enough they can then be used for inter and intra chip communications.

To couple the output of the laser efficiently into an optical fibre and to ensure reliable positioning of the fibre with respect to the end of the laser waveguide, standard silicon micro-machining techniques can be used to for a V-groove 21 at the end of the waveguide as shown in FIG. 14. An optical fibre can then be placed in the groove 21 and glued into position. A chip containing both the laser and the processing electronics can then be hermetically sealed into a standard ‘pig-tailed’ device package.

The second embodiment has been described with reference to the use of erbium but it will be understood that any suitable rare earth may be used. Indeed, a combination of more than one rare earth could be used in the emitting layer of any embodiment.

Although two embodiments have been described as a “buried ridge” waveguide on a silicon wafer and as a ridge waveguide mounted on a silicon-on-insulator wafer, it will be appreciated that other configurations will fall within the scope of the invention. For example, it is also possible to form a waveguide in a slab of silicon by doping the region each side of where the light will propagate. Similarly, it will be understood that the Bragg reflectors of the first embodiment and the mirrors of the second will be interchangeable. Bragg reflectors are formed by regularly spaced grooves cut into the waveguide, and can give the high reflectivity needed, and have narrow spectral widths which will force the laser to operate over a narrow wavelength range.

It may also be possible to use the distributed feedback (DFB) approach that has been used in traditional semiconductor lasers.

1. A light-emitting system comprising an organic light-emitting device containing a rare earth fabricated on a silicon-based substrate and a resonant cavity within which light emitted by said light-emitting device propagates.

2. A light-emitting system as claimed in claim 1, wherein the rare earth is erbium.

3. A light-emitting system as claimed in claim 1, wherein the rare earth is ytterbium or neodymium.

4. A light-emitting system as claimed in claim 1, 2 or 3, wherein the resonant cavity comprises a waveguide structure on the silicon-based substrate, the waveguide structure having reflective means at each end so as to form the resonant cavity.

5. A light-emitting system as claimed in claim 4, wherein the waveguide is a planarised or buried ridge waveguide.

6. A light-emitting system as claimed in claim 4 or 5, wherein the light-emitting device is integrated into the waveguide structure.

7. A light-emitting system as claimed in claim 4, 5 or 6, wherein the waveguide follows a coiled path.

8. A light-emitting system as claimed in any of claims 4 to 7, wherein the reflective means are mirrors.

9. A light-emitting system as claimed in any of claims 4 to 7, wherein the reflective means are Bragg reflectors.

10. A light-emitting system as claimed in any preceding claim, which its a laser.

11. A light-emitting system as claimed in claim 10, wherein the laser operates at about 1.5 μm.

12. A light-emitting system as claimed in claim 10, wherein the laser operates at about 1 μm.

13. A light-emitting system as claimed in claim 10, wherein the laser operates at about 0.9 μm.

14. A light-emitting system as claimed in any preceding claim, further comprising a modulator associated with the resonant cavity.

15. A light-emitting system comprising an organic light-emitting device fabricated on a silicon-based substrate, a resonant cavity within which light emitted by said light-emitting device propagates, and a modulator associated with the resonant cavity.

16. A light-emitting system as claimed in claim 14 or 15, wherein the modulator comprises a diode for the injection of free carriers into the resonant cavity.

17. A light-emitting system as claimed in claim 14, 15 or 16, wherein the modulator is located in the resonant cavity.

18. A light-emitting system as claimed in claim 14, 15 or 16, wherein the modulator is a polymer or small molecule organic waveguide modulator.

19. A light-emitting system as claimed in any of claims 14 to 18, wherein modulation of the light emitted by the system is effected by the injection of free carriers so as to change the refractive index of the resonant cavity.

20. A light-emitting system as claimed in any of claims 14 to 18, wherein modulation of the light emitted by the system is effected by the injection of free carriers so as to change the local absorption of the resonant cavity.

21. A light-emitting system as claimed in any preceding claim, wherein the silicon-based substrate incorporates a groove for receiving an optical fibre.
